(19) United States
(12) Patent Application Publication
(10) Pub. No.: US 2021/0260526 A1
(43) Pub. Date: Aug. 26, 2021

(54) REACTIVE SORBER APPARATUS, SYSTEM AND METHOD FOR GAS PURIFICATION

(71) Applicant: MECHEM LAB LTD., Nesher (IL)

(72) Inventors: Konstantin CHUNTONOV, Migdal Haemek (IL); Boris VERBITSKY, Haifa (IL)

(73) Assignee: MECHEM LAB LTD., Nesher (IL)

(21) Appl. No.: 16/500,817

(22) PCT Filed: Jun. 6, 2017
(86) PCT No.: PCT/IB2017/053325

§ 371 Date: Oct. 4, 2019

(51) Int. Cl. B01D 53/83; B01D 53/12; C25B 1/04; C25B 15/08; C01B 3/56; C01B 21/04; B01J 20/04

(52) U.S. Cl. CPC B01D 53/83; C01B 2203/042; C25B 1/04; C25B 15/085; C01B 3/56; C01B 21/0427; B01J 20/04; B01D 2251/302; B01D 2251/304; B01D 2251/404; B01D 2251/402; B01D 2251/406; B01D 2251/408; B01D 2253/1122; B01D 2256/16; B01D 2256/10; B01D 2259/40084; C01B 2210/0007; B01D 53/12

(57) ABSTRACT

Reactive sorber is a flow sorption column for purification of gases at pressures till hundreds of bars by way of chemical capturing of impurities by metallic powder reactant (6). The powder is continuously rubbed in the process of mechanical stirring and is sorted with the help of a filtering divider (8) into two fractions, activated particles and exhausted material (12). The latter is removed into a waste collector (11, 13), which has a level meter calibrated in the units of purity of the gas exiting from the sorber.

### FIELD OF THE INVENTION

The present invention relates to equipment intended for gas purification, in particular, to flow sorption columns with mechanical activation of a metallic chemisorbent.

### BACKGROUND

The method of passing the gas to be purified through a immobile porous chemisorbent is widely used in the production of high purity gases. An example of equipment working with this principle is a gas purifier. Due to the simplicity of their design they are used quite widely. However, they possess the feature, which is inherent in all periodically charged sorption columns: the rate of capturing gases monotonically decreases with time. At a certain moment the gas sorption rate goes down to a critical value [Chuntonov et al. Getters: From Classification to Materials Design. Journal of Materials Science and Chemical Engineering, 2016, 4, 23-34] and then it is necessary to stop the process because otherwise the concentration of the impurity in the product of purification starts exceeding the allowable limit. The problem is that for today's chemisorbents the critical moment comes too early, when the share of the spent material is still too small [Chuntonov, K. and Setina, J. Reactive getters for MEMS applications. Vacuum, 2016, 123, 42-48] and that for the known gas purifiers there is no other possibility to define the approximation of the sorption rate to the red line than with the help of expensive analytical systems, the price of which exceeds the price of the gas purifiers.

As concerns the first disadvantage, it is possible to intensify chemical reactions between the sorbent and gases and to increase the sorption efficiency of gas purification technologies in the following ways. One consists in replacement of adsorbents with reactants, in the case of which not just the surface but the entire volume of the material participates in capturing of gases [Chuntonov et al. Getters: From Classification to Materials Design. Journal of Materials Science and Chemical Engineering, 2016, 4, 23-34]. Another one consists in mechanical activation of a chemisorbent in the medium of the treated gas. This method has many advantages, however, both variants of the activation, the mechanical [U.S. Pat. No. 9,095,805] and the fluidized bed [U.S. Pat. No. 9,586,173], are intended for gas lines working with a pressure not higher than 5 bar.

Below, we describe a solution which eliminates the mentioned disadvantages, in particular, allowing mechanical activation of the getter material at high pressures (including pressures of hundreds bar) and at the same time monitoring the quality of the end product.

### SUMMARY OF THE INVENTION

The subject of the present invention is gas purification equipment of a new type created on the bases of high pressure reactors with magnetic stirrer. With the help of a number of design changes this kind of a reactor is turned into a high output sorption column with practically exhaustion of the sorption material. This is achieved due to the continuous renewal of the reaction boundary gas/solid, where the solids are powder particles of the alloy containing alkali and/or alkaline-earth metals.

The body of the sorption column, which, taking into consideration the specificity of its operation and its purpose, can be called a reactive sorber, consists of a head and two chambers, an upper and a lower one, with a filtering divider between them. Sorption powder and a stirrer, the actuator of which is located under the head, are in the upper chamber (reactor). When the stirrer is rotated a constituent, which is directed upwards, appears in the trajectory of the mixed particles, while the gas flow is directed from above downwards, which answers the principle of a counter-flow.

While in gas purifiers, where the powder is motionless, mass transfer processes slow down with time due to the growth of the layer of products on the surface of the particles, in reactive sorbers the kinetic of interaction between the getter material and gases is maintained at the highest level due to the continuous reproduction of fresh metallic regions on the surface of rubbing particles. During the process of stirring the products of reaction are the first to be removed from the surface of the particles. They pour down in the form of nano- and micro particles through the filtering divider from the upper chamber into the lower one, where the waste is collected. As a result, the prevailing part of the powder mass reacts with the impurity gases before the sorption rate decreases to the critical value.

Another advantage of reactive sorbers over the traditional gas purifiers relates to the problem of quality control of the end gas product. For many users of high purity gases it is enough to know that the gas they are using fits in the required purity range and so there is no need in the detailed picture of the impurity distribution according to their chemical composition. This makes the problem easier and it can be solved thanks to the existence of the clear correlation between the gas sorption rate and the amount of the exhaust sorbent.

The practical employment of this correlation for the purposes of monitoring the purity of the exiting from the sorber gas becomes possible only now with the appearance of a reactive sorber, where the powder mass during the entire technological process is subjected to sorting into two fractions, into active particles and waste. In technical respect this solution comes down to the installation of a level meter into the waste collector. The level meter tracks the height h of the column of waste and informs when the system comes close to the critical point.

### BRIEF DESCRIPTION OF THE DRAWINGS

FIG. 1 depicts a reactive sorber according to one preferred embodiment of the present disclosure and the principle of the design.

FIG. 2 shows a theoretical graph of time dependent sorption rate j(t) and critical sorption rate j_{c}.

FIG. 3 shows a reactive sorber according to one preferred embodiment of the present disclosure in an industrial variant.

FIG. 4 shows the waste management in an sorber system according to one preferred embodiment of the present disclosure.

### DETAILED DESCRIPTION OF THE INVENTION

Reactive sorbers are a new class of sorption columns intended for the production of high purity gases and ultrapure gases. They can be considered as a hybrid of gas purifiers with a powder reactant and high pressure reactors with a magnetic stirrer. The integration of the technological functions and the constructional ideas of these two chemical processing units allow creating a new kind of gas purification equipment, where the consumable material demonstrates higher sorption efficiency due to its activation in the medium of the flow gas. The dissimilarity from the previously described activation methods like grinding of suspended particles as a result of chaotic impacts in turbulent gas flows [U.S. Pat. No. 9,586,173] or milling monolithic ingots with cutting tools [U.S. Pat. No. 9,095,805] is that in the present invention the particles are activated in the process of mutual rubbing at their mechanical stirring with the moderate rate by an impeller.

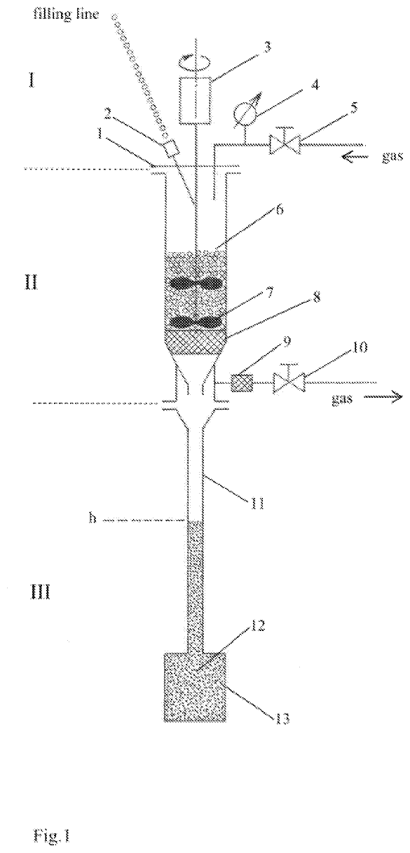

The design of a reactive sorber is schematically shown in FIG. 1. The reactive sorber of the embodiment to the present disclosure shown in FIG. 1 has three detachable parts: a head I, an upper chamber II and a lower chamber III. Head I represents by itself a flange 1 with a connecting port 2, with an actuator 3, on the shift of which a stirrer 7 is fixed, and with a gas inlet. Chamber II is in the essence a reactor, in which the powder reactant 6 reacts with gas to be purified coming from above along the gas line with valve 5 and going out in the purified form through valve 9. The powder of the reactant is stirred with a magnetic stirrer of pitched blade or helical impeller type, the blades of which are close to the surface of the filtering divider 8 and, in one preferred embodiment, directly slide along it. In the process of stirring, an abrading (or rubbing) of the products of reaction located on the particle surface occurs and said abraded particles pour down in the form of nano- and micro particles through the openings of filter 8 into the lower chamber III (FIG. 1). So, the particle surface is continuously renewed and the specific sorption rate, that is the rate per unit of the powder mass, remains constant and close to the value, which is characteristic of the fresh metallic surface.

Nevertheless, the general sorption rate, i.e. the sorption rate of the entire powder mass 6 with time decreases. However, this takes place not for the reason of kinetic difficulties but due to the “natural wear”, because of the decrease of the size of the particles at their abrading/rubbing, which leads to the decrease of the total surface area of the powder. This side of the process can be regulated. In one embodiment, the preferred regime of gas purification for the reactive sorber is the following: gas purification at ambient temperature (i.e. without heating or cooling); employing slow or moderate rates of rotating the stirrer, preferably in the range from 0.5-20, more preferably 1 to 10 rev/s, which answers the regime of surface rubbing and not of impact fracture of solids; following the ratio 4.5≤D/d≤5.0, where D is an average size of the initial particles of the reactant and d is a diameter of the openings of filtering divider 8 (FIG. 1). The said ratio means that ˜95 vol % of the powder charge, that is, its major part, sorbs gases not in the limiting diffusion regime but with extremely high rate. Stirring the powder in accordance with the mentioned ratios is the condition under which the sorption potential of the reactant is maximally used.

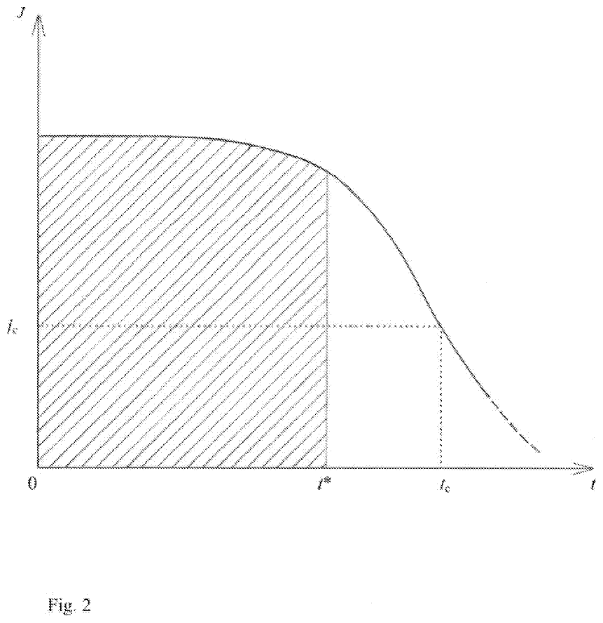

While chamber II is intended for providing extremely high gas gettering rate and practically complete exhaustion of the sorption material, chamber III, i.e. the collector of solid waste, is intended for providing reliability of the process systems, for which the reactive sorber is the source of consumable gas. The problem of reliability appears here for the reason that the dependence of the sorption rate j on time t (FIG. 2) has a form of monotonously decreasing curve j(t), each point of which answers the certain purity level of the gas exiting from the sorber. Sooner or later there comes a moment when the value j reaches the critical value j_{c}, after which the purity of the end product inevitably goes below the acceptable level. So it becomes necessary to timely determine the coordinate t_{c} in order to take safety measures, e.g. by terminating the production process or switching the gas line to a sorber with the fresh charge.

Different values, which are functionally connected with the sorption rate j(t), could become the indirect indicator of purity of the gas product; however, from the consideration of convenience the preference was given to such value as the amount of the consumed for the given moment sorption material. The ground for this decision can be obtained from the analysis of FIG. 2.

On integrating the function j(t) with respect to t over the interval from zero to some arbitrary time t*, we get the value of the current sorption capacity q=∫₀^{t*}j(t)dt, where q is the amount of gas sorbed by the powder reactant by the moment t*. In FIG. 2, the shaded area corresponds to the value q. Let us denote the gas impurity by Y, then we can write down the sorption process in a form of reaction Me(s)+Y(g)=MeY(s), where Me is a reactant, MeY is a product of the reaction (waste), and s and g point to solid and gaseous state accordingly. Here from it is seen that the amount of waste MeY equal to m_{MeY}=q(1+M_{Me}/M_{Y}), where Mₘₑ and M_{Y} are atomic masses of the reactant and the impurity Y accordingly, correspond to the amount q of the sorbed gas Y and the amount of waste m_{MeY}(t_{c})=q(t_{c})(1+M_{Me}/M_{Y}) corresponds to the amount of gas q(t_{c}) sorbed by the critical moment t_{c}. As far as the purity of the exiting gas at any moment of time is uniquely connected to the value of j(t) and, consequently, to the value q(t) as well, we come to the conclusion that we have good reason to use the value m_{MeY}(t) as an indicator of the instantaneous gas purity grade.

Therefore, in one embodiment of the present disclosure, the issue of quality control of the end gas product comes down to issue of measuring the amount of waste and further to the issues of the accuracy of measurements and the further calibration. In the reactive sorber of the present embodiment, this kind of measurements are easy to perform due to the continuous division the consumable powder into two separated in space fractions, into material, which has already reacted, and the material, which has not yet reacted. The motion of blades 7 and the presence of filtering divider 8 (FIG. 1) force the powder particles to sorting according to their size: the small particles of the products of reactions fall down into chamber III, the purified gas goes out through filter 10 and valve 9 and the larger active particles remain in chamber II and continue sorbing gas impurity.

In one embodiment of the present disclosure, the quantitative data on the exhausted fraction can be received by measuring the height of the powder column 12 in chamber III. It is designed to get precise results at measurements (FIG. 1): the volumes of drum 13 and tube 11 relate approximately as 3:1 and their diameters as 3.5:1. From these two relations the second one increases the sensibility of the measuring procedure to changes in volume of the waste. The measure of these changes is the increment in the height Δh of the powder column at the increase of waste volume by the value of Δv, where v is the volume of exhausted material. As far as Δh˜(1/d)² Δv, where d is the diameter of the cylindrical container with waste, for increasing the size of the value, which is being measured, it is advantageous to decrease diameter d. In one embodiment 3.5-fold decrease of the diameter of tube 11 compared with the diameter of the drum leads to ˜10-fold increase of the value h and, accordingly, to the same increase in the accuracy of the measurement results. Further on, the first and the second ratios taken together considerably decrease the overall dimensions of chamber III. Due to these two ratios by the time when the curve j(t) starts approaching the critical rate j_{c} (FIG. 2) the main mass of waste is already taken by drum 13 while the first portions of the exhausted material only start appearing in tube 11.

Drum 13 and tube 11 can be connected in their contact position by welding or with the help of standard high pressure techniques like flange connections or coned and threaded connections suggested by many manufacturers, e.g. Swagelok, High Pressure Equipment Company, Separex, Buchiglas, etc. There is a wide choice of design solutions and standard products applicable for the role of tube 11. In the same way it is easy to find a reliable method of detecting the boundary h, which separates the gas phase from the powder column in tube 11 (FIG. 1). So, in some embodiments and in the case of an all-metal level meter the coordinate h can be found with the help of the gamma method or the Ultrasonic Through the Wall Technology (KC Controls) and in the case of level meters with a glass window—by direct reading. The example of the second case can be single tube level indicators from Quest-Tec Solutions, transparent armored gauges from Jerguson, etc.

In one embodiment of the present disclosure, the operation of charging the reactive sorber with powder material is provided. While the products of reaction with gases are mainly stable chemical compounds and there are no difficulties with their unloading from the sorber, the initial powders of reactive alloys are extremely active and for this reason are to be reliably protected from the contact with the ambient atmosphere.

Two methods are known for the transportation of reactive powders from the vacuum mill to the hermetical vessel, where they are further used as gas sorbents. One is charging of the sorption material in gas purifiers [U.S. Pat. No. 9,586,173], another—in vacuum insulated glazing (patent pending). In both cases it is necessary to perform a multistage procedure, which employs additional specific equipment and which in both cases ends in sealing of the metallic filling pipe under vacuum.

In one embodiment of the present invention, an easier technique of introducing reactive powder into gas filled chambers, in particular, into a reactive sorber, is provided. Filling the reactive sorber with active powder and further pressure tight sealing after the charging is completed is performed in the atmosphere of an inert gas, e.g. argon, although the all the same operations can be carried out in the media of the gas to be purified. In one preferred embodiment, the procedure comprises the following steps. The vacuum mill with the ingot of a reactive alloy inside is connected to the reactive sorber via the straight-line port 2 (filling line in FIG. 1 is none other than the indication of the position taken by a metallic filling pipe), the inner atmosphere of the sorber and the mill is evacuated, then this volume is purged with pure argon, which is fed through valve 5 while valve 9 is closed.

The ingot is milled in argon atmosphere at the pressure of about 1 bar. During milling the powder particles are continuously poured into the sorber along the filling pipe till complete milling of the entire ingot. The size of the ingot exactly corresponds to the volume of powder 6 in the starting state of the sorber (FIG. 1). After the sorber is filled with powder the pressure of argon in the system sorber-mill is slowly increased receiving the gas along the line with valve 5 and letting it out at the excess pressure of 0.15-0.25 bar through a safety relief valve installed in the mill. Then the filling pipe is disconnected from port 2 and port 2 is closed in the flow of exiting argon with a high pressure plug or cap using for sealing standard products of companies like Parker, Swagelok, Circor, etc. If the gas to be purified is argon from this moment the sorber is ready for operation; if not, then it is necessary to purge the sorber with the gas to be purified.

Thus, uniting two technological units, a high pressure reactor with a magnetic stirrer and a gas purifier with powder reactant, allows creating a sorption column with extremely high sorption efficiency and with a level meter, which informs when the system approaches to the threshold value of purity of the gas product.

High sorption efficiency in the present embodiment is the result of a preferred ratio 4.5≤D/d≤5.0 of two values, diameter D of the filled into the sorber powders and diameter d of the openings in the filtering divider, and also the result of the surface rubbing of the particles at low rotation rates of the stirrer, approximately from 1 to 10 rotation per second. The chemical nature of the reactant contributes into the mentioned efficiency: high activity of alloys of alkali and alkali-earth metals and their favorable for rubbing mechanical properties.

The sectional structure of the sorber, where the reactor with the active material and the waste collector with the exhausted material are separated geometrically, provides the possibility of performing the measurements of the amount of exhausted material getting the information about the quality of the gas product with the help of such a simple tool as a level meter. Obviously, this solution is more preferable for the industry than continuous analysis of the chemical composition of the purified gas using the complicated analytical equipment like, e.g. Atmospheric Pressure Chemical Ionization Mass Spectrometer.

Reactive sorbers in their technical and economical parameters by many times excel everything that is known in the field of production of pure and ultra pure gases. Thus, gas purifiers with reactive metallic powder are about 10 times inferior to sorbers in sorption capacity because sorption rate in motionless powders decreases with time faster than at stirring and for this reason reaches the critical value earlier. This conclusion is confirmed by experimental data obtained on powders of Ba₈Ga, LiGa [symbol] Ba_{0.8}In_{0.2} [Chuntonov, K. and Setina, J. Reactive getters for MEMS applications. Vacuum, 2016,123, 42-48]: abrupt decrease in sorption rate is observed already starting from 5-10% exhaustion of the initial getter mass while the reactive sorber provide 95% of exhaustion.

Mechanochemical sorption apparatuses are also inferior to sorbers although the reactions between powders and gases in both cases takes place on the fresh surface and dependences of the sorption rate on time here are close. In the given case the advantage of the sorbers is due to the fact that they are not limited by the pressure of 5 bar like mechanochemical apparatuses but are capable of working at hundreds of bars and so are by many times superior in the efficiency, that is in the amount of gas purified per unit of time.

If sorbers are compared with gas purifiers, in which not reactants but metallic adsorbents like Nb, Ni, Ti, V, Zr are used, in this case the superiority of sorbers in sorption capacity is already 1000-fold. Besides, at room temperature transition metals are not able to remove such impurity as nitrogen and the expenses for the production of getter materials from these metals are approximately by 10 times higher than the expenses of powder reactants containing Na, Li, Ca, Mg, Sr and Ba.

Moreover, the technical advantages of sorbers allow them going beyond the frames of traditional applications of getter materials. High sorption efficiency of the activated powders and their low production cost increase the profitability of getter purification. It becomes profitable even there, where the contamination level of the treated gas is by 3 orders of magnitude higher than the one, the current getter technologies are dealing with. In certain cases it is profitable even where the concentration of impurity gases is not 0.005-0.01 vol % but ˜20 vol %. And here it is not necessary to run the purification process at high pressures; and reactive sorbers themselves can be manufactured in different modifications targeted for working at atmospheric pressure, at pressures of 10 bar, 100 bar, 275 bar, etc.

Applications of this kind are, for example, processes of recycling of exhausted rare gases with the concentration of the main substance around 80 vol % while the regular getter purification starts from the purity grade of 4N-4.5N. Let us mention alloys of BaₓLi₁₋ₓ with 0.2≤x≤0.3 or BaₓMg₁₋ₓ with 0.45≤x≤0.65 as a reactant, which removes all active and low activity gases from the treated gas mixture. Similar embodiments are used for systems of maintaining inert atmosphere in glove boxes or in storage cabinets, for example, when the process gas is nitrogen produced with the help of a reactive sorber directly from the ambient air. Here powders of the composition CaₓMg₁₋ₓ with 0.6≤x≤0.7, which remove all gases except nitrogen and argon, can serve as a reactant.

In one embodiment of the present disclosure, in which the reactive sorber radically improves gas purification technology, is a hydrogen generator using water electrolysis. A reactive sorber with powder of the composition CaₓLi₁₋ₓ, where 0.35≤x≤0.45, purifies the gas coming from a cathode in one stage process without preliminary treatment and brings the purity of the end product to the required value, e.g. to 6N, 7N, 8N, etc.

### Other Embodiments

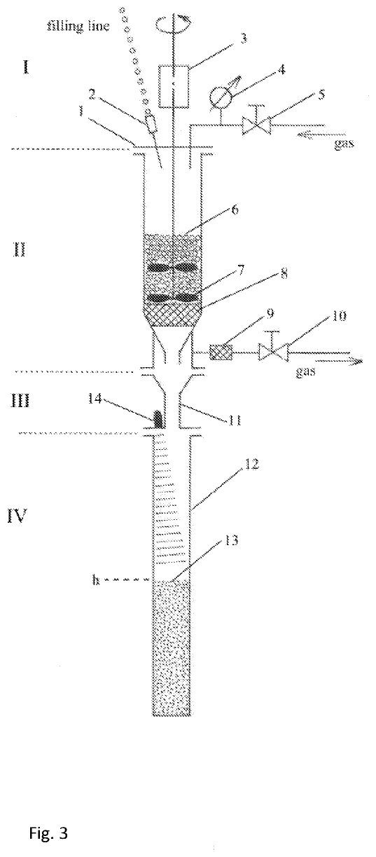

If the usable volume, i.e. the volume of the powder charge of the reactive sorber, amounts to liters then the productivity of such a sorber is equal to the productivity of an industrial column. In this case it is more profitable to make the sorber design 4-sectional (FIG. 3) in order to decrease height and to make the procedure of unloading the exhausted material from the waste collector easier.

This is achieved due to shortening the length of tube 11 and turning it into an independent and detachable section III, which is connected with the waste collector 12 with the help of flanges. Section IV is made in a form of a container 12, which collects powder waste 13. The level h of the column of waste is now measured by a non-contact radar (FMCW) level meter, the sensor 14 of which is installed on the flange (FIG. 3).

In one embodiment, the reactants of different composition and, besides, used in different processes performs a calibration step for each application. The readings of the height h can be presented in the units of purity of the gas product. In other words, during the calibration of this kind the experimental values of the level h are related to experimental data on the chemical composition of the gas, which is obtained at the outlet of the sorber.

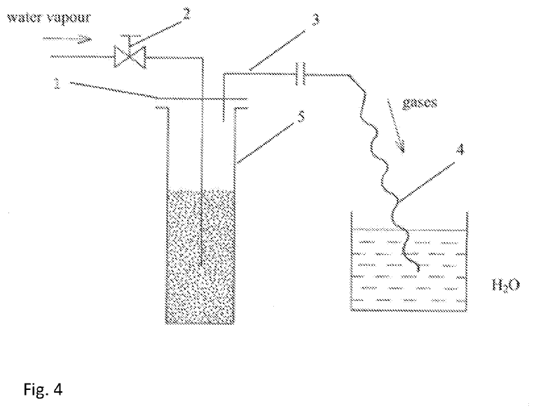

Sections I and II of a sorber of industrial scale are basically identical to what was discussed earlier (FIG. 1). Waste neutralization in both cases is carried out also in a similar way (FIG. 4). Although this procedure depends on the concrete circumstances, in preferred embodiments of the present disclosure, the general rule comes down to the following: first the sorber is filled with inert gas. e.g. argon, and then the lower section with the waste is disconnected and closed with head 1 (FIG. 4).

In one embodiment, the end of the flexible hose 4 is dipped in a water can and argon with water vapor is fed into the waste collector via valve 2 gradually replacing argon with pure water vapor. The aim of this procedure is to turn the entire mass of the waste into concentrated water solution of salts and hydroxides of Me and after the procedure of air calcination to obtain the material, which easily returns into the initial metallic state with the help of the known technological steps.

### FIG. 1. Reactive Sorber: Principle of the Design.

I—a head with a rotary actuator, port 2 and gas inlet, II—an upper chamber (a reactor), III—the lower chamber (waste collector).

1—a flange; 2—a connecting port, which connects the reactor with the mill by a metallic pipe and is sealed by a cap or a plug after the powder is charged; 3—a rotary actuator, the shaft of which is connected with a stirrer; 4—a manometer; 5—a valve of the gas inlet; 6—powder of reactant; 7—blades of the stirrer; 8—a filtering divider; 9—a valve of the gas outlet; 10—a filter for capturing dust; 11—a metallic tube, which connects the reactor with the waste connector and is at the same time a level meter; 12—exhausted material; 13—a waste drum; h—the surface of the waste column.

FIG. 2. Sorption Rate j(t) and Critical Sorption Rate j_{c}.

The purity of the gas coming out from the sorber expressed via concentration of the impurity x is functionally connected with amount m_{MeY} of the exhausted powder, which is convenient to be measured by the height h of the waste column. The calibration of the level meter is performed by building up experimentally two dependences, x(t) and h(t), which provide the resulting curve h=f(x), on which the critical point is the value of h_{c}=f[x(t_{c})], where x(t_{c}) is the set level of purity of the gas product.

### FIG. 3. Reactive Sorber: Industrial Variant.

I—a head, II—a reactor, III—a tube, connecting the reactor with a waste collector, IV—a waste collector.

1—a flange, 2—a connecting port, which connects the reactor with the mill by a metallic pipe and is sealed by a cap or plug after the powder is charged; 3—a rotary actuator, the shaft of which is connected with a stirrer; 4—a monometer, 5—a valve of the gas inlet, 6—powder of reactant; 7—blades of the stirrer; 8—a filtering divider; 9—a valve in the gas outlet line; 10—a filter for capturing dust; 11—a metallic tube connecting the reactor with the waste collector, 12—a container with waste; 13—exhausted material, 14—a level sensor installed on the flange of section III; h—the surface of a column of waste.

### FIG. 4. Waste Management

1—a head; 2—a valve; 3—outlet; 4—a hose; 5—a container with the waste.

### Summary of Preferred Embodiments

In one preferred embodiment of the present disclosure, a reactive sorber system for purification of flow gases from active and low activity gas impurities is provided, comprising a high pressure reactor with a magnetic stirrer, a collector of solid waste and a filtering divider between the reactor and the waste collector.

In one preferred embodiment of the present disclosure, in said reactive sorber the inlet of the gas to be purified is located on the head of the reactor and the outlet of the purified gas is located under the filtering divider.

In one preferred embodiment of the present disclosure, in said reactive sorber the reactor is filled with powder particles of the alloy, the components of which are selected from the group of metals: Na, Li, Ca, Mg, Sr, Ba.

In one preferred embodiment of the present disclosure, in said reactive sorber the reactor is filled with powder in the atmosphere of argon through the connecting port on the head of the reactor and through the metallic pipe connecting the port with the mill.

In one preferred embodiment of the present disclosure, in said reactive sorber after filling the reactor with powder the metallic pipe is disconnected and the connecting port is pressure-tight sealed in the flow of argon exiting from the reactor.

In one preferred embodiment of the present disclosure, in said reactive sorber the size of openings d in the filtering divider and the size D of the filled into the reactor powder particles relate as 4.5≤D/d≤5.0.

In one preferred embodiment of the present disclosure, in said reactive sorber the rate of rotating the stirrer is in the range from 1 to 10 rotations per second.

In one preferred embodiment of the present disclosure, in said reactive sorber the waste collector is equipped with a level meter informing about the moment when the gas purification should be stopped.

In one preferred embodiment of the present disclosure, a method of production of high purity or ultra pure gases is provided by way of passing them through a reactive sorber with a layer of reactive powder, which is mechanically activated during stirring.

In one preferred embodiment of the present disclosure, in said method the rotation rate of the stirrer does not exceed 10 rotations per second.

In one preferred embodiment of the present disclosure, in said method in the process of stirring the powder mass is continuously sorted in the medium of the treated gas with the help of a filtering divider into two fractions, into active particles remaining in the reactor and smaller particles of waste falling down into a waste collector.

In one preferred embodiment of the present disclosure, in said method the result of sorting is set by the ratio 4.5≤D/d≤5.0, where D is an average size of the particle, which are filled into the reactor, and d is the size of the openings in the filtering divider.

In one preferred embodiment of the present disclosure, in said method the reactive powder is produced from an alloy, the components of which are metals, selected from the group: Na, Li, Ca, Mg, Sr, Ba.

In one preferred embodiment of the present disclosure, in said method the purity of the inlet gas is in the range from 90 to 99.995%.

In one preferred embodiment of the present disclosure, in said method with the aim of recycling of the exhauster rare gases the mixture, entering in the sorber, contains about 80 vol % of the target gas and the composition of the purification powder is BaₓLi₁₋ₓ with 0.2≤x≤0.3 or BaₓMg₁₋ₓ with 0.45≤x≤0.65.

In one preferred embodiment of the present disclosure, in said method the purified gas is hydrogen coming from an electrolyzer into the sorber with powder of the composition CaₓLi₁₋ₓ, where 0.35≤x≤0.45.

In one preferred embodiment of the present disclosure, in said method the sorber is used as a nitrogen generator for the creation and maintenance of inert atmosphere inside the glove box of the storage cabinets by capturing of all the constituents of the air except argon and nitrogen by powders of CaₓMg₁₋ₓ, where 0.6≤x≤0.7.

1. Reactive sorber apparatus for purification of gases, comprising:
a sealed reactor vessel,
a stirrer disposed in the reactor vessel and rotatable in the reactor vessel;
a gas inlet connected to the reactor vessel at a position above the stirrer;
an inlet for reactive powder particles;
a filter divider disposed in a bottom area of the reactor vessel at a position below the stirrer;
a collector vessel for solid waste arranged below and connected to the filter divider;
a gas outlet connected to the collector vessel; and
a sensor unit adapted for detecting a current waste filling amount of the collector vessel.

2. Reactive sorber apparatus according to claim 1, wherein the reactor vessel is a high pressure reactor vessel and the stirrer is an axial stirrer, preferably selected from the group, consisting of a magnetic stirrer, a rod stirrer, a blade stirrer, and a screw stirrer.

3. (canceled)

4. Reactive sorber apparatus according to claim 1, further comprising a controller coupled to the sensor unit and adapted for controlling the reactive sorber apparatus to stop operating if the filling height of the collector vessel reaches a predetermined value.

5. Reactive sorber apparatus according to claim 1, wherein the sensor unit comprises a level meter detecting the waste filling height of the collector vessel.

6. Reactive sorber apparatus according to claim 1, wherein the inlet for reactive powder particles is connected to a milling apparatus.

7. Reactive sorber system for purification of gases, comprising:
a reactive sorber apparatus according to one of the preceding claims; and
reactive powder particles disposed in the sealed reactor vessel.

8. Reactive sorber system according to claim 7, wherein the reactive powder particles have an average diameter, D, which is at least two times larger than the diameter, d, of openings in the filter divider.

9. Reactive sorber system according to claim 8, wherein the diameter, d, of the opening in the filter divider and the average diameter, D, of the powder particles fulfil the requirement 4.5≤D/d≤5.0.

10. Reactive sorber system according to claim 7, wherein the powder particles are made from an alloy comprising at least one component selected from the group: Na, Li, Ca, Mg, Sr, and Ba.

11. Method of producing high purity or ultra-pure gas by way of passing the gas through a reactive sorber system according to claim 7, comprising:
introducing a gas to be purified through the gas inlet of the reactive sorber system; and
flowing the gas to purified from the gas inlet through the reactive powder particles which are stirred by the stirrer and the filter divider to the gas outlet such that the gas passing through the reactive powder particles is purified,
wherein the stirred powder particles are continuously sorted in the medium of the treated gas with the help of the filtering divider into active powder particles remaining in the reactor vessel and smaller inactive particles of waste falling down through the filtering divider into a waste collector,
wherein the inactive waste particles are continuously formed during operation of the reactive sorber system by abrasion of inactive surface material of the powder particles during stirring of the powder particles.

12-13. (canceled)

14. The method according to claim 11, further comprising
Filling reactive powder particles from the inlet for reactive powder particles into the reactor vessel under an inert gas atmosphere;
Removing a powder particle feed line from the inlet for reactive powder particles such that inert gas exits the reactor vessel through the inlet for reactive powder particles; and
Sealing the inlet for reactive powder particles while inert gas streams out to avoid contamination of the reactor vessel with ambient atmosphere.

15. The method according to claim 14, wherein the inert gas is argon.

16. The method according to claim 11, wherein, with the aim of recycling the exhauster rare gases, the gas mixture to be purified entering the reactive sorber system contains about 80 vol % of the target gas and the composition of the purification powder is BaₓLi₁₋ₓ with 0.2≤x≤0.3 or BaₓMg₁₋ₓ with 0.45≤x≤0.65.

17. The method according to claim 11, wherein the purified gas is hydrogen coming from an electrolyzer into the reactive sorber system with powder of the composition CaₓLi₁₋ₓ, with 0.35≤x≤0.45.

18. The method according to claim 1, wherein the reactive sorber system is used as a nitrogen generator for the creation and maintenance of inert atmosphere inside the glove box of the storage cabinets by capturing of all the constituents of the air except argon and nitrogen by powders of CaₓMg₁₋ₓ, with 0.6≤x≤0.7.
